(19) United States
(12) Patent Application Publication
(10) Pub. No.: US 2001/0019642 A1
(43) Pub. Date: Sep. 6, 2001

(54) Arrangement for reducing the stimulated brillouin scattering in an optical waveguide fiber

(76) Inventor: Peter Krummrich, Muenchen (DE)

Correspondence Address: Schiff Hardin & Waite, Patent Department, 6600 Floor Sears Tower, 233 South Wacker Drive, Chicago, IL, 60606, US

(21) Appl. No.: 09/742,846

(22) Filed: Dec. 20, 2000

(30) Foreign Application Priority Data
Dec. 20, 1999 (DE) 19961514.4

(51) Int. Cl. G02B 6/26

(52) U.S. Cl. 385/27; 385/15; 385/50

(57) ABSTRACT

The formation of a mechanical wave having a greater amplitude and therefore a stimulated Brillouin scattering is prevented in that the light waveguide transmission is divided into different sections and in that the sections are acoustically decoupled from one another. This can also be achieved in that the phase relationship between the fed-in and optical wave or, respectively, backscattered light wave is disturbed by longitudinal non-homogeneities of the fiber or by purposeful destructive interference.

### BACKGROUND OF THE INVENTION

The present invention is directed to an arrangement for reducing the stimulated Brillouin scattering commonly referred to as SBS in an optical waveguide fiber, such as a transmission fiber.

The stimulated Brillouin scattering occurs when light, which has a low bandwidth and is above a critical power, is transmitted via an optical fiber. As a result of mechanical oscillations of the fiber, an optical wave of low frequency occurs, which returns to the fiber entry. The backscattered optical wave prevents the transmission of a higher performance to the fiber output end.

It is known from U.S. Pat. No. 4,560,246, whose disclosure is incorporated herein by reference thereto, that a broadband light source reduces the Brillouin effect. This broadband source can be generated by modulating a narrow-band light source.

The disadvantage of these two measures is that the spectrum expands, so that the dispersion problem occurs. A modulation is also problematic for coherent systems.

It is known from an article by Dammig et al entitled “Stimulierte Brillouin-Streuung in Glasfasern” from Phys. BI, Vol. 50, No. 12 (1994), pp. 1129-1134, to achieve a significant increase of the Brillouin threshold influencing the Brillouin shift. For this purpose, periodic modulations of variables can be used, which influence the Brillouin shift via the refractive index or the speed of sound. These can be mechanical tensions caused by an appropriate cabling, variations of the doping via the fiber length, a splicing of different fiber types or the utilization of periodic temperature gradients.

### SUMMARY OF THE INVENTION

The present invention is based on the object of proposing a concrete solution for increasing the Brillouin threshold.

This object is achieved by various arrangements, such as the optical waveguide being divided into sections which are acoustically decoupled against one another and in which a disturbing Brillouin scattering will not occur. Another arrangement is an optical transmission fiber, which exhibits hazardous or quasi-hazardous changes in its longitudinal non-homogeneities, which result in different spreading speeds of the optical and acoustic waves and which thereby disturbs the phase relation between transmitted optical signals waves and an excited acoustic or backscattered optical waves. Yet another way is to insert a fiber section having a deviated spreading speed for either the optical waves or acoustic waves in the transmission fiber with the length and spreading speeds of the fiber sections being dimensioned so that a destructive interference will occur.

Of these different solutions, an advantageous one is to prevent the formation of acoustic wave in the transmission fiber, with this prevention being by dividing the fiber into sections that are decoupled against one another.

Another possibility for suppression of the stimulated Brillouin scattering is by continuously changing the spreading or dispersion conditions for the acoustic wave. Fibrous grids having different grid spacings are formed, which prevent the coherence between a fed and a sound wave or, respectively, a reflected light wave.

The same effect for suppression can be achieved by inserting fiber sections having different spreading speeds for acoustic waves or for inserting fiber sections which have both waves exhibit different spreading factors, which, however, have a different correlation to one another.

It is also possible to select fiber sections such that the reflected waves extinguish each other as far as possible.

Other advantages and features of the invention will be readily apparent from the following description of the preferred embodiments, the drawings and claims.

### BRIEF DESCRIPTION OF THE DRAWINGS

FIG. 1 shows a light waveguide transmission fiber with an acoustic decoupling;

FIG. 2 is another example of a light waveguide transmission fiber with a variable jacket diameter;

FIG. 3 is a view of a transmission fiber with inserted fiber sections, which exhibit different spreading speeds for light; and

FIG. 4 is a view of a transmission fiber with inserted fiber sections, which exhibit different spreading speeds for sound.

### DESCRIPTION OF THE PREFERRED EMBODIMENTS

The principles of the present invention are particularly useful when incorporated in an optical transmission fiber 1, which is divided into a plurality of fiber sections 2, 3 and 4. The fiber sections are acoustically decoupled against one another and are fixed by mechanical splices 5. Air, oil or other non-conducting or poorly conducting medium are situated between the fiber sections. The fiber ends 6 and 7 are skewed in order to avoid optical reflections.

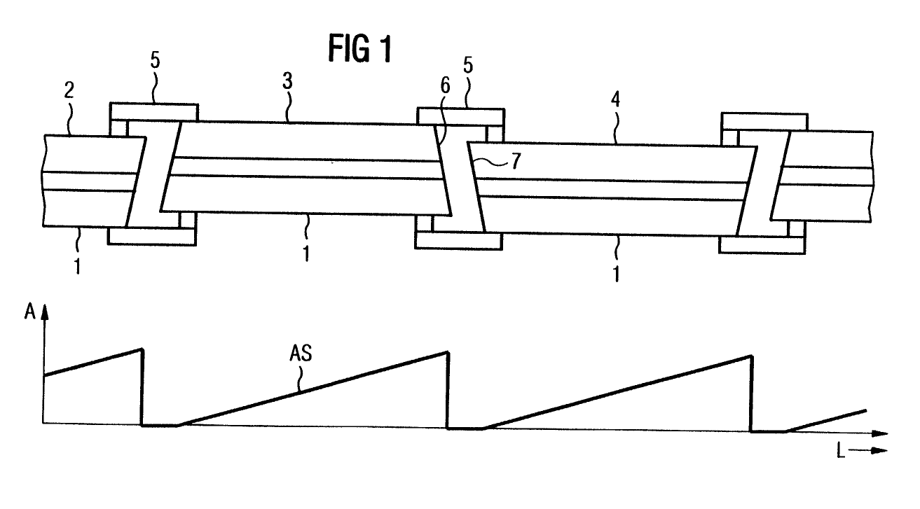

An acoustic wave AS cannot disseminate beyond the splices so that it must slowly build up again at the beginning of each new fiber section. The amplitude A of the acoustic wave AS is represented along the fiber of FIG. 1 with respect to the length of each section. The amplitude of the acoustic wave is altogether a lot lower than in a continuous fiber, and this would lead to a more weakly fashioned refractive index grid and, therefore, to a lower stimulated Brillouin scattering. The task of the splices can be assumed by a coating or, when fibers are provided with coatings, it can be assumed by a protective casing, sheath or cladding, which surrounds the fiber including the coating.

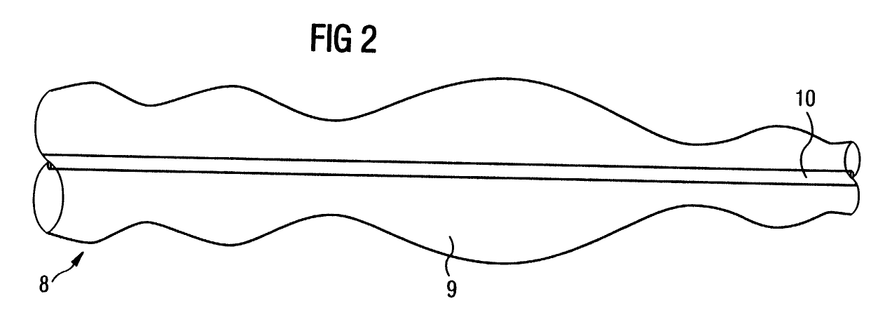

In FIG. 2, a light waveguide transmission fiber 8 is indicated and has a fiber core 10 whose cladding 9 or coating, depending on the length, exhibits a changing diameter or a fluctuating spreading speed for sound waves as a result of material changes. This variation in either the diameter or the spreading speed will result in a formation of different fiber grids by means of which the coherence is disturbed between the transmitted light and the forming sound wave, as well as the backscattered light. The forming fiber grid is to reflect the acoustic wave or is to overcouple it into modes, which do not contribute to the stimulated Brillouin scattering. A corresponding effect can occur by doping the cladding, by tensile stress or compressive strain, by other glass compositions of the fiber and its treatment or by mechanical tension during cabling. The phase relationship between the optical signal wave and the acoustic wave or, respectively, the backscattered optical wave are disturbed again by the longitudinal nonhomogeneity.

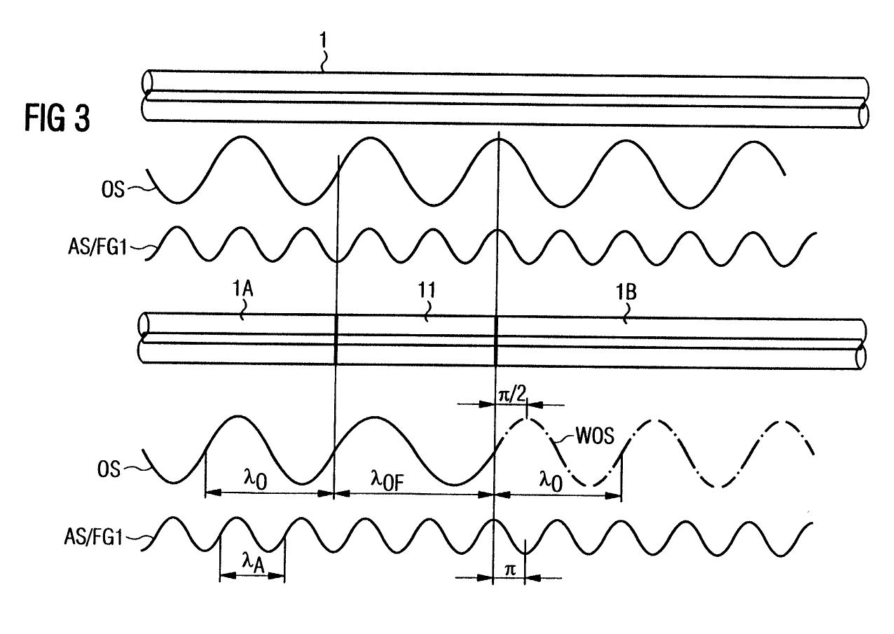

In FIG. 3, an upper portion shows an optical waveguide OS fed into a light waveguide transmission fiber 1 and shows the acoustic wave AS generated by it. The lower part shows a modification of the light waveguide transmission fiber having a fiber section 11 inserted between the first fiber section 1A and the second fiber section 1B. It is noted that only a single inserted section is shown with the first fiber section 1A extending to the entry portion of the waveguide and the second fiber section 1B of the transmission fiber to the exit portion of the waveguide. The fiber section 11 exhibits a different spreading speed for an optical signal, whereby the acoustic spreading speed remains the same. In order to avoid problems with reflections of the optical signals, the transitions between the fiber sections must be correspondingly fashioned.

The origination of the backscattering is to be initially explained as follows. The fed-in optical signal OS having a wavelength λ₀ creates the formation of a fiber grid FG1, whose wavelength λ_{A} corresponds approximately to half of the wavelength of the optical wave OS and which partially reflects the optical signal in an assumed stationary state. Since the fiber grid, however, moves toward the fiber end with the forming acoustic wave, the reflected optical signal, the stimulated Brillouin backscattering will exhibit a lower frequency than the optical signal OS as a result of the Doppler's effect to be considered twice for the fiber grid moving toward the fiber end and the backscattered wave. With the insertion of the fiber section 11, whose optical spreading speed is different, for example higher, and whose length is selected such that, due to an increased wavelength λ_{OF} after the fiber section has passed, a phase modification results by one quarter of the optical wavelength (π/2) of the phase-shifted optical wave WOS vis-a-vis the original optical wave, when it was able to pass fiber section 11 in an unmodified fashion, and, therefore, to the not-yet modified fiber grid. If one observes the longer forward path of the optical wave up to the fiber grid FG2, which occurs in the section 11, and the return path of the backscattered wave, a phase shift is achieved of π vis-a-vis the backscattered optical wave, which came into existence in the fiber section at the entry side and, therefore, an optimum destructive interference occurs. The lengths and frequencies of the fiber sections 1A and 1B, which essentially determine the amplitude of the backscattered signal, are selected so that an optimum reduction of the stimulated Brillouin scattering occurs.

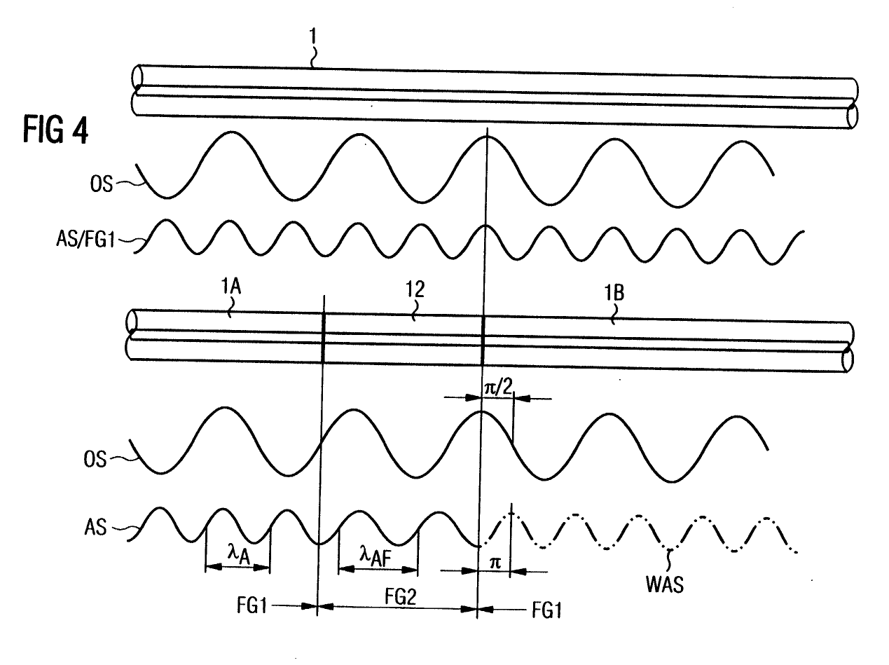

In FIG. 4, a light waveguide transmission fiber, which has fiber sections 12 inserted, is shown with different spreading speeds for acoustic signals. In order to avoid problems with reflection of the optical signals, the core of the fiber and, therefore, the spreading conditions are to be as constant as possible. As a result of the optical signal OS, an acoustic wave forms, which has a wavelength λ_{AF} that is different vis-a-vis the wavelength λ_{A} present in the fiber sections 1A and 1B. A fiber grid FG2 forms in the inserted section 12, which, however, exhibits different grid spacings vis-a-vis the phase grid FG1. The length of the inserted fiber section is selected so that for a homogeneous fiber, a phase change occurs of π of the phase-shifted acoustic wave WAS vis-a-vis the original acoustic wave or, respectively π/2 for the optical wave. If one observes, again, the forward path of the optical signal and the return path of the backscattered wave, an optimum destructive interference of the backscattered waves is achieved, so that the conditions for forming a disturbing stimulated Brillouin scattering are disadvantageously disturbed. The frequency difference between the fed optical signal and the backscattered optical signal has been neglected in these observations.

Mixed systems from the exemplary embodiments according to FIGS. 3 and 4 can easily be obtained. Only a phase shift of the optical wave vis-a-vis the acoustic wave and, therefore, vis-a-vis the fiber grid in the fiber section 1B is essential. The fiber sections 11 and 12 with deviating spreading speeds can occur from splicing, changing the cladding diameter or doping.

Although various minor modifications may be suggested by those versed in the art, it should be understood that I wish to embody within the scope of the patent granted hereon all such modifications as reasonably and properly come within the scope of my contribution to the art.

I claim:

1. An arrangement for reducing the stimulated Brillouin scattering in an optical waveguide fiber, said arrangement including an optical wave fiber being divided into sections, said sections being acoustically decoupled against one another so that a disturbing Brillouin scattering does not occur.

2. An arrangement according to claim 1, wherein the optical fiber is divided into sections which are connected to one another by acoustically insulating mechanical splices.

3. An arrangement according to claim 1, wherein the optical fiber is divided into a plurality of sections which are coupled together by a coating.

4. An arrangement according to claim 1, wherein the optical fiber is divided into a plurality of sections which are coupled together by an additional protecting cladding on the optical fiber.

5. An arrangement according to claim 1, wherein the fiber ends of each of the sections are skewed to avoid optical reflections.

6. An arrangement for reducing the stimulated Brillouin scattering in a transmission fiber, said arrangement comprising the transmission fiber being provided which has changes in its longitudinal non-homogeneities, which result in different spreading speeds of a wave selected from optical waves and acoustic waves, and which disturbs the phase relationship between a transmitted optical wave and thereby excited acoustic and backscattered optical waves.

7. An arrangement according to claim 6, wherein the transmission fiber exhibits different spreading speeds for sound signals.

8. An arrangement for reducing stimulated Brillouin scattering in an optical transmission fiber, said arrangement comprising at least one fiber section having a deviating spreading speed for optical waves being inserted into the transmission fiber, with one of the length and spreading speeds of the fiber section being dimensioned so that destructive interference occurs between the reflected light waves.

9. An arrangement according to claim 8, wherein a length of the at least one fiber section is dimensioned so that a phase change results of at least approximately nπ/2, wherein n=1, 3, 5 of the phase-shifted optical wave vis-a-vis the original optical wave and the fiber grid after passing the fiber section.

10. An arrangement according to claim 8, wherein fiber sections having different spreading speeds are inserted more frequently in an area of an input end of the fiber and inserted less frequently with an increasing distance from said input end.

11. An arrangement for reducing the stimulated Brillouin scattering in an optical transmission fiber, said arrangement comprising at least one fiber section having a deviating spreading speed for an acoustic wave being inserted in the light waveguide transmission fiber, said fiber sections having one of the length and spreading speeds dimensioned so that a destructive interference occurs between the reflected optical waves.

12. An arrangement according to claim 11, wherein the at least one fiber section has a length that is dimensioned so that the phase change results in nπ, wherein n=1, 3, 5 of the phase-shifted acoustic wave, so that the fiber grid generated by a phase-shifted acoustic wave vis-a-vis the optical wave is phase-shifted by at least approximately nπ/2 of the optical wave.

13. An arrangement according to claim 11, wherein the diameter of the introduced fiber section is modified vis-a-vis one of the remaining portions of the transmission fiber.
